(19) United States
(12) Patent Application Publication
(10) Pub. No.: US 2024/0161977 A1
(43) Pub. Date: May 16, 2024

(54) METHOD OF MANUFACTURING MULTILAYER ELECTRONIC COMPONENT

(71) Applicant: SAMSUNG ELECTRO-MECHANICS CO., LTD., Suwon-si (KR)

(72) Inventors: Eung Seok LEE, Suwon-si (KR); Tae Gyun KWON, Suwon-si (KR); So Hyeon HONG, Suwon-si (KR)

(73) Assignee: SAMSUNG ELECTRO-MECHANICS CO., LTD., Suwon-si (KR)

(21) Appl. No.: 18/110,012

(22) Filed: Feb. 15, 2023

(30) Foreign Application Priority Data
Nov. 10, 2022 (KR) 10-2022-0149437

(51) Int. Cl. H01G 4/008; H01G 4/012; H01G 4/248; H01G 4/30

(52) U.S. Cl. CPC H01G 4/0085; H01G 4/012; H01G 4/248; H01G 4/30

(57) ABSTRACT

A method of manufacturing a multilayer electronic component including: a first operation of obtaining a layer pattern constituting one layer by performing at least one of a process of forming a dielectric pattern by ejecting a ceramic ink containing a dielectric material and a photocurable resin, a process of forming an internal electrode pattern by ejecting a first metal ink containing conductive particles for internal electrodes and a photocurable resin, and a process of forming external electrode patterns by ejecting a second metal ink containing conductive particles for external electrodes and a photocurable resin; a second operation of obtaining a cured layer pattern by irradiating the layer pattern with ultraviolet light to cure the layer pattern; obtaining a laminate in which a plurality of cured layer patterns are stacked by carrying out a plurality of the first and second operations; and sintering the laminate.

### CROSS-REFERENCE TO RELATED APPLICATION(S)

This application claims benefit of priority to Korean Patent Application No. 10-2022-0149437 filed on Nov. 10, 2022 in the Korean Intellectual Property Office, the disclosure of which is incorporated herein by reference in its entirety.

### BACKGROUND

### 1. Technical Field

The present disclosure relates to a method of manufacturing a multilayer electronic component.

### 2. Description of Related Art

A multilayer ceramic capacitor (MLCC), one of multilayer electronic components, is a chip-type condenser mounted on a printed circuit board for use in various electronic products, such as image devices, e.g. a liquid crystal display (LCD) and a plasma display panel (PDP), computers, smartphones, and mobile phones, to serve to charge or discharge electricity therein or therefrom.

The multilayer ceramic capacitor may be used as a component for various electronic devices because it has a small size, secures a high capacitance, and is easy to mount. In accordance with decreases in size and increases in output of various electronic devices such as computers and mobile devices, there has been an increasing demand for a decrease in size and an increase in capacitance of the multilayer ceramic capacitor.

Conventionally, a screen-printing technique or a gravure printing technique has been used as a method of manufacturing a multilayer ceramic capacitor. However, in the screen-printing technique or the gravure printing technique, defects such as cracks may occur through various processes such as pattern printing, lamination, cutting, plasticization, sintering, polishing, and external electrode application. In addition, the screen-printing technique or the gravure printing technique has a limitation in reducing a thickness of dielectric layers and a thickness of internal electrodes, and has a problem of low process efficiency because consumables for molding such as PET films are required, and a paste for internal electrodes, a dielectric slurry, and the like remain.

In order to overcome such limitations, a method of manufacturing a multilayer ceramic capacitor using an inkjet printing technique has recently been proposed. However, when dielectric patterns, internal electrode patterns, and external electrode patterns to be described below are formed using the inkjet printing technique, the patterns may be mixed with each other, and accordingly, a multilayer electronic component may have a shape defect. Therefore, there is a need for research on a method of manufacturing a multilayer ceramic capacitor capable of improving process efficiency and reducing a defect rate by securing interface stability between dielectric patterns, internal electrode patterns, and external electrode patterns.

### SUMMARY

An aspect of the present disclosure may provide a method of manufacturing a multilayer electronic component with excellent process efficiency.

Another aspect of the present disclosure may provide a method of manufacturing a multilayer electronic component capable of reducing a defect rate by improving interface stability between dielectric patterns, internal electrode patterns, and external electrode patterns.

According to an aspect of the present disclosure, a method of manufacturing a multilayer electronic component including a body comprising dielectric layers and a plurality of internal electrodes stacked with the dielectric layers interposed therebetween, and external electrodes disposed externally on the body includes: a first operation of obtaining a layer pattern constituting one layer by performing at least one of a process of forming a dielectric pattern by ejecting a ceramic ink containing a dielectric material and a first photocurable resin, a process of forming an internal electrode pattern by ejecting a first metal ink containing conductive particles for the internal electrodes and a second photocurable resin, and a process of forming external electrode patterns by ejecting a second metal ink containing conductive particles for the external electrodes and a third photocurable resin; a second operation of obtaining a cured layer pattern by irradiating the layer pattern with ultraviolet light to cure the layer pattern; an operation of obtaining a laminate in which a plurality of cured layer patterns are stacked by carrying out a plurality of the first and second operations; and a sintering operation of obtaining the multilayer electronic component by sintering the laminate.

According to another aspect of the present disclosure, a method of manufacturing a multilayer electronic component including a body comprising dielectric layers and a plurality of internal electrodes stacked with the dielectric layers interposed therebetween, and external electrodes disposed externally on the body includes: a first operation of obtaining a layer pattern constituting one layer, the first operation includes forming external electrode patterns by ejecting a metal ink containing conductive particles for external electrodes and a photocurable resin to form the external electrodes; and a second operation of obtaining a cured layer pattern by irradiating the layer pattern with ultraviolet light to cure the layer pattern, wherein at least a portion of the first operation is carried out simultaneously with the second operation.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a multilayer electronic component manufactured by a manufacturing method according to an exemplary embodiment of the present disclosure;

FIG. 2 is a schematic cross-sectional view illustrating a cross section taken along line I-I′ of FIG. 1;

FIGS. 3A through 4B are schematic cross-sectional views illustrating a process of obtaining a laminate by performing first and second operations multiple times included in a method of manufacturing a multilayer electronic component according to an exemplary embodiment of the present disclosure; and

FIG. 5 is a schematic cross-sectional view illustrating a process of obtaining a cured layer pattern by carrying out the first and second operations included in the method of manufacturing the multilayer electronic component according to an exemplary embodiment of the present disclosure.

### DETAILED DESCRIPTION

Hereinafter, exemplary embodiments of the present disclosure will now be described in detail with reference to the accompanying drawings.

In the drawings, a first direction may be defined as a thickness T direction, a second direction may be defined as a length L direction, and a third direction may be defined as a width W direction.

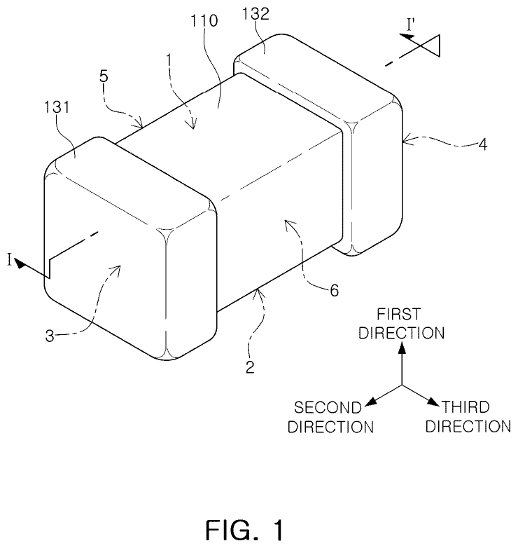

FIG. 1 is a schematic perspective view illustrating a multilayer electronic component manufactured by a manufacturing method according to an exemplary embodiment of the present disclosure.

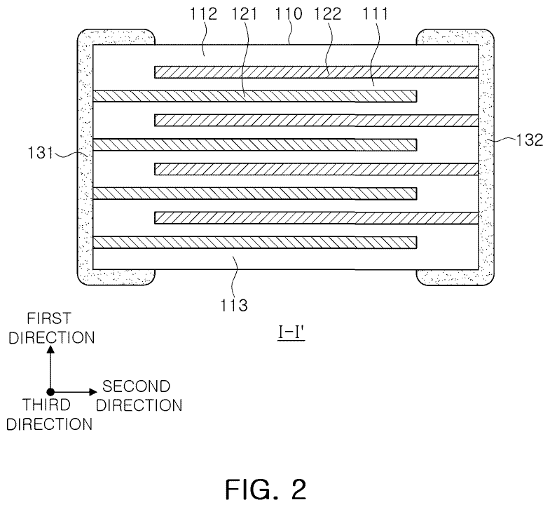

FIG. 2 is a schematic cross-sectional view illustrating a cross section taken along line I-I′ of FIG. 1.

Hereinafter, a multilayer electronic component 100 manufactured by a manufacturing method according to an exemplary embodiment of the present disclosure will be briefly described with reference to FIGS. 1 and 2.

A specific shape of a body 110 is not particularly limited, and may be a hexahedral shape or a shape similar to the hexahedral shape as illustrated. The body 110 may have first and second surfaces 1 and 2 facing each other in the first direction, third and fourth surfaces 3 and 4 connected to the first and second surfaces 1 and 2 and facing each other in the second direction, and fifth and sixth surfaces 5 and 6 connected to the first to fourth surfaces 1 to 4 and facing each other in the third direction.

In the body 110, the dielectric layers 111 and the internal electrodes 121 and 122 may be alternately stacked. The plurality of dielectric layers 111 forming the body 110 may be in a sintered state, and adjacent dielectric layers 111 may be integrated with each other so that boundaries therebetween are not readily apparent without using a scanning electron microscope (SEM).

It is not necessary to particularly limit an average thickness of the dielectric layers 111. For example, the average thickness of the dielectric layers 111 may be arbitrarily set according to desired characteristics of the multilayer electronic component 100 or what the multilayer electronic component 100 is used for by adjusting an ejection amount of a ceramic ink and/or the number of times the ceramic ink is ejected, which will be described below. The average thickness of the dielectric layers 111 may be, for example, 10 μm or less, 0.4 μm or less, or 300 nm or less for microminiaturizing the multilayer electronic component and increasing a capacitance of the multilayer electronic component.

Here, the average thickness of the dielectric layers 111 refers to an average size of the dielectric layers 111 disposed between the internal electrodes 121 and 122 in the first direction. The average thickness of the dielectric layers 111 may be measured by scanning cross sections of the body 110 in the first and second directions with a scanning electron microscope (SEM) having a magnification of 10,000. More specifically, an average value may be measured by measuring thicknesses of one of the dielectric layers 111 at a plurality of points, for example, at 30 points equally spaced apart in the second direction. The equally-spaced 30 points may be chosen within a capacitance forming portion, which will be described below. In addition, if the measurement of the average value expands to 10 dielectric layers 111, the average thickness of the dielectric layers 111 may be further generalized. Other methods and/or tools appreciated by one of ordinary skill in the art, even if not described in the present disclosure, may also be used.

The internal electrodes 121 and 122 may be arranged alternately with the dielectric layers 111. For example, each of the first internal electrodes 121 and each of the second internal electrodes 122, which are a pair of electrodes having different polarities, may be disposed to face each other with each of the dielectric layers 111 interposed therebetween. The plurality of first internal electrodes 121 and the plurality of second internal electrodes 122 may be electrically insulated from each other by the dielectric layers 111 disposed therebetween.

Each of the plurality of first internal electrodes 121 may be disposed to be spaced apart from the fourth surface 4 and connected to the third surface 3. In addition, each of the plurality of second internal electrodes 122 may be disposed to be spaced apart from the third surface 3 and connected to the fourth surface 4.

It is not necessary to particularly limit an average thickness of the internal electrodes 121 and 122. For example, the average thickness of the internal electrodes 121 and 122 may be arbitrarily set according to desired characteristics of the multilayer electronic component 100 or to the type of application for which the multilayer electronic component 100 is used by adjusting an ejection amount of a first metal ink containing conductive particles for internal electrodes and/or the number of times the first metal ink is ejected, which will be described below. The average thickness of the internal electrodes 121 and 122 may be, for example, 3 μm or less, 0.4 μm or less, or 300 nm or less for microminiaturizing the multilayer electronic component and increasing a capacitance of the multilayer electronic component.

In the conventional screen-printing and gravure printing techniques, internal electrode patterns are formed using a conductive paste containing conductive particles for internal electrodes and a printing plate. However, when the internal electrode patterns are formed using the printing plate, there may be a problem that the internal electrode patterns are deformed due to printing pressure. In addition, since it is difficult to accurately print internal electrode patterns before being sintered, there is a limitation in reducing a thickness of internal electrodes. In contrast, in a method of manufacturing a multilayer electronic component according to an exemplary embodiment of the present disclosure, internal electrode patterns are formed by ejecting a first metal ink containing conductive particles for internal electrodes, for example, using an inkjet technique, thereby making it possible to achieve internal electrodes having a thin thickness of 300 nm or less.

The average thickness of the internal electrodes 121 and 122 refers to an average size of the internal electrodes 121 and 122 in the first direction. Here, the average thickness of the internal electrodes 121 and 122 may be measured by scanning cross sections of the body 110 in the first and second directions with a scanning electron microscope (SEM) having a magnification of 10,000. More specifically, an average value may be measured by measuring thicknesses of one of the internal electrodes 121 and 122 at a plurality of points, for example, at 30 points equally spaced apart in the second direction. The equally-spaced 30 points may be chosen within a capacitance forming portion, which will be described below. In addition, if the measurement of the average value expands to 10 internal electrodes 121 and 122, the average thickness of the internal electrodes 121 and 122 may be further generalized. Other methods and/or tools appreciated by one of ordinary skill in the art, even if not described in the present disclosure, may also be used.

The body 110 may include a capacitance forming portion disposed in the body 110 and forming a capacitance by including the first and second internal electrodes 121 and 122 disposed alternately with the dielectric layers 111 interposed therebetween, and first and second cover portions 112 and 113 formed on both end surfaces of the capacitance forming portion facing each other in the first direction, respectively. The cover portions 112 and 113 may basically serve to prevent damage to the internal electrodes due to physical or chemical stress. The cover portions 112 and 113 may have the same configuration as the dielectric layers 111, except that internal electrodes are not included therein.

The external electrodes 131 and 132 may be disposed on the third and fourth surfaces 3 and 4 of the body 110, respectively, and may extend to partial portions of the first, second, fifth, and sixth surfaces. In addition, the external electrodes 131 and 132 may include a first external electrode 131 connected to the plurality of first internal electrodes 121 and a second external electrode 132 connected to the plurality of second internal electrodes 122.

At this time, a region of the first external electrode 131 disposed on the third surface of the body may be defined as a first connection portion, and a region of the first external electrode 131 disposed to extend from the first connection portion to partial portions of the first, second, fifth, and sixth surfaces of the body may be defined as a first band portion. Also, a region of the second external electrode 132 disposed on the fourth surface of the body may be defined as a second connection portion, and a region of the second external electrode 132 disposed to extend from the second connection portion to partial portions of the first, second, fifth, and sixth surfaces of the body may be defined as a second band portion.

Each of the dielectric layers 111, the internal electrodes 121 and 122, and the external electrodes 131 and 132 of the multilayer electronic component 100 manufactured by the manufacturing method according to an exemplary embodiment of the present disclosure may include a photocurable resin. As will be described below, some of the photocurable resin contained in the ceramic ink, the first metal ink, and the second metal ink forming the dielectric layers 111, the internal electrodes 121 and 122, and the external electrodes 131 and 132, respectively, may remain in the dielectric layers 111, the internal electrodes 121 and 122 and the external electrodes 131 and 132. However, the present disclosure is not limited thereto, and the photocurable resin may not remain in the dielectric layers 111, the internal electrodes 121 and 122, and/or the external electrodes 131 and 132 if entirely burned during a sintering process.

Each of the internal electrodes 121 and 122 and the external electrodes 131 and 132 of the multilayer electronic component manufactured by the manufacturing method according to an exemplary embodiment of the present disclosure may contain a ceramic material. As will be described below, in the manufacturing method according to an exemplary embodiment of the present disclosure, the dielectric layers 111, the internal electrodes 121 and 122, and the external electrodes 131 and 132 may be simultaneously sintered. At this time, the ceramic material contained in the internal electrodes 121 and 122 and the external electrodes 131 and 132 may serve to delay the sintering of the internal electrodes 121 and 122 and the external electrodes 131 and 132, which are sintered at a faster speed than the dielectric layers 111.

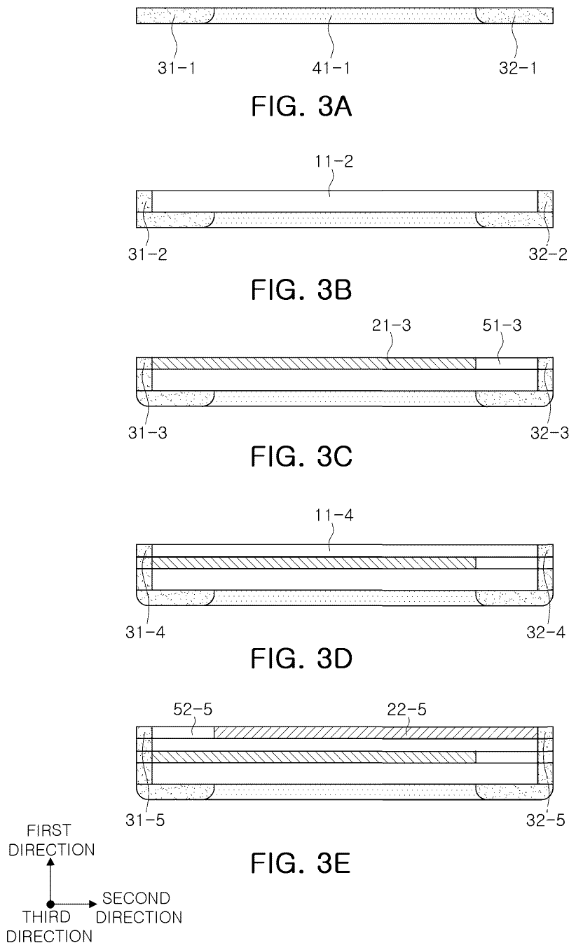

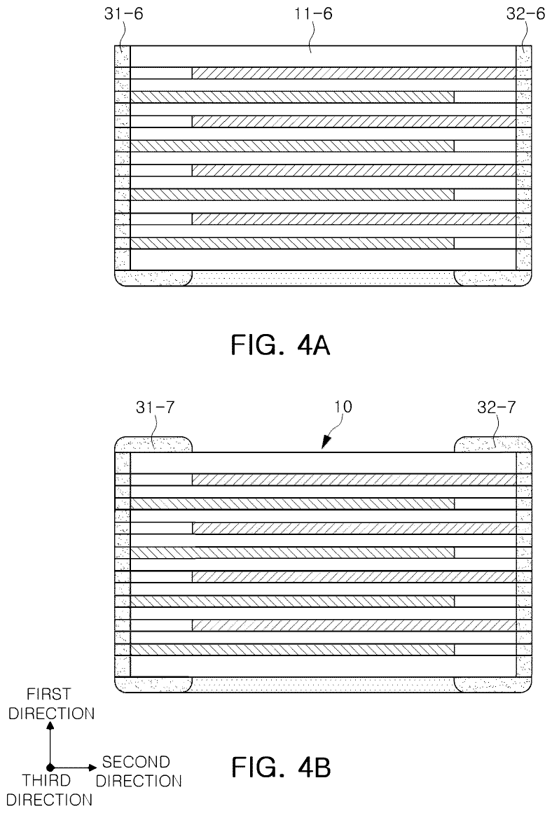

FIGS. 3A through 4B are schematic cross-sectional views illustrating a process of obtaining a laminate by performing first and second operations multiple times included in a method of manufacturing a multilayer electronic component according to an exemplary embodiment of the present disclosure.

Hereinafter, a method of manufacturing the above-described multilayer electronic component will be described with reference to FIGS. 3A to 4B.

A method of manufacturing a multilayer electronic component according to an exemplary embodiment of the present disclosure, which is a method of manufacturing the multilayer electronic component 100 including a body 110 including dielectric layers 111 and a plurality of internal electrodes 121 and 122 stacked with the dielectric layers interposed therebetween, and external electrodes 131 and 132 disposed outside the body, may include: a first operation of obtaining a layer pattern constituting one layer by performing at least one of a process of forming a dielectric pattern 11-2, 11-4, or 11-6 by ejecting a ceramic ink containing a dielectric material and a photocurable resin, a process of forming an internal electrode pattern 21-3 or 22-5 by ejecting a first metal ink containing conductive particles for internal electrodes and a photocurable resin, and a process of forming external electrode patterns 31-1 and 32-1, . . . , or 31-6 and 32-6 by ejecting a second metal ink containing conductive particles for external electrodes and a photocurable resin; a second operation of obtaining a cured layer pattern by irradiating the layer pattern with ultraviolet light to cure the layer pattern; an operation of obtaining a laminate 10 in which a plurality of cured layer patterns are stacked by carrying out the first and second operations multiple times; and a sintering operation of obtaining the multilayer electronic component by sintering the laminate.

First, a ceramic ink for forming dielectric patterns, a first metal ink for forming internal electrode patterns, a second metal ink for forming external electrode patterns, and an organic ink for forming a support pattern 41-1 are prepared. The dielectric patterns may form dielectric layers 111 by sintering, the internal electrode patterns may form internal electrodes 121 and 122 by sintering, and the external electrode patterns may form external electrodes 131 and 132 by sintering. As will be described below, the support pattern may form at least a portion of an external shape of the laminate 10, and may serve to maintain the shape of the laminate 10.

The ceramic ink may contain a dielectric material and a photocurable resin. The dielectric material is not particularly limited as long as it is capable of providing a sufficient capacitance. For example, the dielectric material may include one or more of BaTiO₃, SrTiO₃, CaZrO₃, MgO, SiO₂, Al₂O₃, Cr₂O₃, MnO₂, Y₂O₃, CaTi, ZrO₃, SrZrO₃, BaTi, and CaO₃.

A ratio of a volume of the dielectric material to a total volume of the ceramic ink is not particularly limited, but may be, for example, 30% to 90%. When the ratio of the volume of the dielectric material to the total volume of the ceramic ink is less than 30%, a layer pattern to be described below may be mixed with another adjacent layer pattern. When the ratio of the volume of the dielectric material to the total volume of the ceramic ink is more than 90%, the fluidity of the ceramic ink excessively deteriorates, which may hinder smooth inkjet printing.

The first metal ink may contain conductive particles for internal electrodes and a photocurable resin, and the second metal ink may contain conductive particles for external electrodes and a photocurable resin. As the conductive particles for internal electrodes and the conductive particles for external electrodes, for example, conductive particles including one or more of Ni, Cu, Pd, Ag, Au, Pt, Sn, W, Ti, and Al may be used. The conductive particles for internal electrodes and the conductive particles for external electrodes may be different from each other, or may be identical to each other.

Each of the first metal ink and the second metal ink may contain a ceramic material. The ceramic material contained in the first and second metal inks may serve to delay sintering. Accordingly, the dielectric patterns, the internal electrode patterns, and the external electrode patterns of the laminate 10 manufactured according to an exemplary embodiment of the present disclosure may be simultaneously sintered.

A ratio of a volume of the conductive particles for internal electrodes to a total volume of the first metal ink and a ratio of a volume of the conductive particles for external electrodes to a total volume of the second metal ink are not particularly limited, but may be, for example, 30% to 90%. When the ratio of the volume of the conductive particles for internal electrodes to the total volume of the first metal ink and the ratio of the volume of the conductive particles for external electrodes to the total volume of the second metal ink are less than 30%, a layer pattern to be described below may be mixed with another adjacent layer pattern. When the ratio of the volume of the conductive particles for internal electrodes to the total volume of the first metal ink and the ratio of the volume of the conductive particles for external electrodes to the total volume of the second metal ink are more than 90%, the fluidity of the first and second metal inks excessively deteriorate, which may hinder smooth inkjet printing.

The organic ink may contain an organic material and a photocurable resin. For example, the organic material contained in the organic ink may include one or more of quinacridone, phthalocyanine, anthraquinone, quinophthalone, perylene, and dioxazine. However, the present disclosure is not limited thereto, and any organic material may be used as long as it is capable of serving to maintain the shape of the laminate 10 and being eliminated by sintering.

The photocurable resin contained in each of the ceramic ink, the first metal ink, the second metal ink, and the organic ink may include an oligomer, a monomer, and a photopolymerization initiator. The photocurable resin may be cured by light in a specific wavelength range, and may be preferably an ultraviolet (UV) curable resin that is cured by ultraviolet light.

The oligomer forms a polymer bond through a photopolymerization reaction, and is not particularly limited. For example, oligomer may include one or more of a polyester-based resin, a urethane-based resin, an epoxy-based resin, and an acrylic-based resin.

The monomer serves as a crosslinking agent and/or a diluent for the oligomer, and is not particularly limited. For example, the monomer may include one or more of 2-ethyl hexyl acetate, 2-hydroxy ethyl acrylate, 2-hydroxy propyl acrylate, 2-hydroxy ethyl acryloyl phosphate, 1,4-butandiol diacrylate, 1,6-hexandiol diacrylate, diethylene glycol diacrylate, neopentyl glycol diacrylate, poly ethylene 400 diacrylate, hydroxy piperidinoic acid ester neopentyl glycol diacrylate, trimethylol propane triacrylate, pentaerythritol triacrylate, and dipentaerythritol hexa acrylate.

The photopolymerization initiator serves to initiate photopolymerization by absorbing light such as ultraviolet light, and is not particularly limited. For example, the photopolymerization initiator may include one or more of 2,2-diethoxy acetophenone, 1-(4-isopropyl phenyl)-2-hydroxy-2-methyl propane-1-one, 2,2-dimethoxy-2-phenyl-acetophenone, hydroxy-cyclohexyl-phenyl, benzophenone, 2-chloro-thioxanthone, benzoin isobutyl ether, and benzoin isopropyl ether.

Each of the ceramic ink, the first metal ink, the second metal ink, and the organic ink may further include additives such as a solvent and a dispersant, if necessary, during the process.

Hereinafter, the operation of obtaining the laminate in which a plurality of cured layer patterns are stacked by carrying out the first and second operations multiple times in the method of manufacturing the multilayer electronic component according to an exemplary embodiment of the present disclosure will be described in detail. Each of the ceramic ink, the first metal ink, the second metal ink, and the organic ink may be ejected in an inkjet manner, and the redundant description will be omitted below.

First of all, as illustrated in FIG. 3A, a first operation of obtaining a first layer pattern constituting one layer may be carried out by performing a process of forming external electrode patterns 31-1 and 32-1 by ejecting the second metal ink and a process of forming a support pattern 41-1 by ejecting the organic ink. At this time, the first external electrode pattern 31-1 may become a partial portion of the first external electrode 131 after being sintered, and the second external electrode pattern 32-1 may become a partial portion of the second external electrode 132 after being sintered.

The support pattern 41-1 may form at least a portion of the external shape of the laminate. For example, the support pattern 41-1 may be included in the first layer pattern to serve to support dielectric patterns and internal electrode patterns to be stacked, and maintain the shape of the laminate.

Next, a second operation of obtaining a cured layer pattern may be carried out by irradiating the first layer pattern including the external electrode patterns 31-1 and 32-1 and the support pattern 41-1 with ultraviolet light to cure the first layer pattern. At this time, the first layer pattern may be quickly cured by the photocurable resin contained in each of the second metal ink and the organic ink.

That is, before forming a second layer pattern on the first layer pattern, the first layer pattern may be quickly cured by irradiating the first layer pattern with ultraviolet light. This prevents the layer patterns from being mixed with each other, and improves interface stability between the dielectric patterns, the internal electrode patterns, and the external electrode patterns stacked according to the method of manufacturing the multilayer electronic component according to an exemplary embodiment of the present disclosure. As a result, it is possible to provide a method of manufacturing a multilayer electronic component capable of reducing a defect rate.

Next, as illustrated in FIG. 3B, a first operation of obtaining a second layer pattern may be carried out by performing a process of forming external electrode patterns 31-2 and 32-2 by ejecting the second metal ink and a process of forming a dielectric pattern 11-2 by ejecting the ceramic ink. The dielectric pattern 11-2 may become the second cover portion 113 after being sintered.

In this case, the process of forming the external electrode patterns may include a process of forming a first external electrode pattern 31-2 disposed at one end of the dielectric pattern 11-2, and a process of forming a second external electrode pattern 32-2 disposed at the other end of the dielectric pattern 11-2.

At this time, at least one of the plurality of first operations, for example, the first operation of obtaining the second layer pattern, may include all of the process of forming the first external electrode pattern 31-2, the process of forming the second external electrode pattern 32-2, and the process of forming the dielectric pattern 11-2.

For example, in a case where printing is performed in the second direction, in the first operation of obtaining the second layer pattern, all of the process of forming the first external electrode pattern 31-2, the process of forming the dielectric pattern 11-2, and the process of forming the second external electrode pattern 32-2 may be performed sequentially. In addition, in a case where printing is performed in the third direction, in the first operation of obtaining the second layer pattern, all of the process of forming the first external electrode pattern 31-2, the process of forming the dielectric pattern 11-2, and the process of forming the second external electrode pattern 32-2 may be performed simultaneously.

That is, by performing an operation including all of the process of forming the first external electrode pattern 31-2, the process of forming the second external electrode pattern 32-2, and the process of forming the dielectric pattern 11-2, it is possible to obtain one layer pattern through the simple processes, and as a result, it is possible to provide a method of manufacturing a multilayer electronic component with excellent process efficiency.

Thereafter, a second operation of obtaining a cured layer pattern may be carried out by irradiating the second layer pattern including the external electrode patterns 31-2 and 32-2 and the dielectric pattern 11-2 with ultraviolet light. At this time, the second layer pattern may be quickly cured by the photocurable resin contained in each of the second metal ink and the ceramic ink.

As described above, by carrying out the second operation between the plurality of first operations, it is possible to improve interfacial stability between the dielectric patterns, the internal electrode patterns, and the external electrode patterns stacked, and as a result, it is possible to provide a method of manufacturing a multilayer electronic component capable of reducing a defect rate. Hereinafter, the redundant description of the second operation will be omitted.

Next, as illustrated in FIG. 3C, a first operation of obtaining a third layer pattern may be carried out by performing a process of forming external electrode patterns 31-3 and 32-3 by ejecting the second metal ink and a process of forming a first internal electrode pattern 21-3 by ejecting the first metal ink, and a second operation of curing the third layer pattern may be carried out.

Next, as illustrated in FIG. 3D, a first operation of obtaining a fourth layer pattern may be carried out by performing a process of forming external electrode patterns 31-4 and 32-4 by ejecting the second metal ink and a process of forming a dielectric pattern 11-4 by ejecting the ceramic ink, and a second operation of curing the fourth layer pattern may be carried out.

Next, as illustrated in FIG. 3E, a first operation of obtaining a fifth layer pattern may be carried out by performing a process of forming external electrode patterns 31-5 and 32-5 by ejecting the second metal ink and a process of forming a second internal electrode pattern 22-5 by ejecting the first metal ink, and a second operation of curing the fifth layer pattern may be carried out.

Referring to FIGS. 3C to 3E, the process of forming the internal electrode pattern may include a process of forming one of the first and second internal electrode patterns 21-3 and 22-5 alternately disposed with the dielectric pattern 11-4 interposed therebetween.

In this case, referring to FIG. 3C, the process of forming the external electrode patterns may include a process of forming a first external electrode pattern 31-3 disposed at one end of the first internal electrode pattern 21-3, and a process of forming a second external electrode pattern 32-3 spaced apart from the first internal electrode pattern 21-3.

In this case, at least one of the plurality of first operations, for example, the first operation of obtaining the third layer pattern, may include all of the process of forming the first external electrode pattern 31-3, the process of forming the second external electrode pattern 32-3, and the process of forming the first internal electrode pattern 21-3.

For example, in a case where printing is performed in the second direction, in the first operation of obtaining the third layer pattern, all of the process of forming the first external electrode pattern 31-3, the process of forming the first internal electrode pattern 21-3, and the process of forming the second external electrode pattern 32-3 may be performed sequentially.

In addition, in a case where printing is performed in the third direction, in the first operation of obtaining the third layer pattern, all of the process of forming the first external electrode pattern 31-3, the process of forming the first internal electrode pattern 21-3, and the process of forming the second external electrode pattern 32-3 may be performed simultaneously.

That is, by performing an operation including all of the process of forming the first external electrode pattern 31-3, the process of forming the second external electrode pattern 32-3, and the process of forming the first internal electrode pattern 21-3, it is possible to obtain one layer pattern through the simple processes, and as a result, it is possible to provide a method of manufacturing a multilayer electronic component with excellent process efficiency.

Referring to FIG. 3E, the process of forming the external electrode patterns may include a process of forming a first external electrode pattern 31-5 spaced apart from the second internal electrode pattern 22-5, and a process of forming a second external electrode pattern 32-5 disposed at one end of the second internal electrode pattern 22-5.

In this case, at least one of the plurality of first operations, for example, the first operation of obtaining the fifth layer pattern, may include all of the process of forming the first external electrode pattern 31-5, the process of forming the second external electrode pattern 32-5, and the process of forming the second internal electrode pattern 22-5.

That is, by performing an operation including all of the process of forming the first external electrode pattern 31-5, the process of forming the second external electrode pattern 32-5, and the process of forming the second internal electrode pattern 22-5, it is possible to obtain one layer pattern through the simple processes, and as a result, it is possible to provide a method of manufacturing a multilayer electronic component with excellent process efficiency.

In addition, referring to FIG. 3C, at least one of the plurality of first operations, for example, the first operation of obtaining the third layer pattern, may further include a process of forming a first step absorbing pattern 51-3 disposed between the first internal electrode pattern 21-3 and the second external electrode pattern 32-3 by ejecting the ceramic ink. Similarly, referring to FIG. 3E, at least one of the plurality of first operations, for example, the first operation of obtaining the fifth layer pattern, may further include a process of forming a second step absorbing pattern 52-5 disposed between the second internal electrode pattern 22-5 and the first external electrode pattern 31-5 by ejecting the ceramic ink.

The first step absorbing pattern 51-3 may serve to absorb a step caused by the thickness of the first internal electrode pattern 21-3, and the second step absorbing pattern 52-5 may serve to absorb a step generated by the thickness of the second internal electrode pattern 22-5. In particular, according to an exemplary embodiment of the present disclosure, the step absorbing patterns 51-3 and 52-5 may be simply formed by ejecting the ceramic ink in an inkjet manner, thereby preventing a shape defect or the like of a multilayer electronic component.

Next, after repeating the processes illustrated in FIGS. 3C to 3E a predetermined number of times, as illustrated in FIG. 4A, a first operation of obtaining a last layer pattern may be carried out by performing a process of forming external electrode patterns 31-6 and 32-6 by ejecting the second metal ink and a process of forming a dielectric pattern 11-6 by ejecting the ceramic ink, and a second operation of curing the last layer pattern may be carried out. In this case, the dielectric pattern 11-6 may become the first cover portion 112 after being sintered.

Thereafter, as illustrated in FIG. 4B, a laminate 10 in which a plurality of cured layer patterns are stacked may be obtained by forming external electrode patterns 31-7 and 32-7, which becomes the band portions of the external electrodes 131 and 132 extending to the first surface of the body 110 after being sintered, by ejecting the second metal ink, and curing the external electrode patterns 31-7 and 32-7.

Referring to FIGS. 3A through 4B, the support pattern 41-1 is included only in the first layer pattern, but the present disclosure is not limited thereto. For example, each of at least two of the plurality of first operations may include a process of forming a support pattern constituting at least a portion of the external shape of the ceramic laminate 10 by ejecting the organic ink. For example, a support pattern may also be disposed, for example, on at least partial portions of both end surfaces of the laminate 10 facing each other in the second direction and/or both end surfaces of the laminate 10 facing each other in the third direction of the laminate 10 to more effectively maintain the shape of the laminate 10.

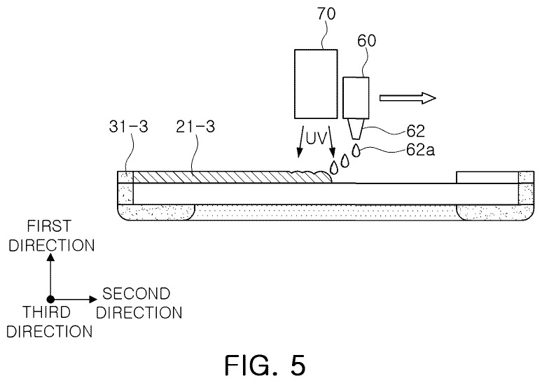

FIG. 5 is a schematic cross-sectional view illustrating a process of obtaining a cured layer pattern by carrying out the first and second operations included in the method of manufacturing the multilayer electronic component according to an exemplary embodiment of the present disclosure.

Referring to FIG. 5, a printing device 60 and an ultraviolet ray irradiating device 70 may be disposed above a region where the layer patterns are to be formed and move along the printing direction. The printing device 60 may include an inkjet head 62 for the first metal ink. In addition, although not illustrated, the printing device 60 preferably includes an inkjet head for the ceramic ink, an inkjet head for the second metal ink, and an inkjet head for the organic ink separately.

Meanwhile, in the method of manufacturing the multilayer electronic component according to an exemplary embodiment of the present disclosure, the first operation and the second operation may be sequentially carried out, but the present disclosure is not limited thereto. At least a portion of the first operation may be carried out simultaneously with the second operation.

For example, as illustrated in FIG. 5, while carrying out a first operation of obtaining a layer pattern by performing a process of forming a first internal electrode patterns 21-3 by ejecting a first metal ink 62a, a second operation may be simultaneously carried out by irradiating the previously formed first internal electrode patterns 21-3 of the same layer pattern with ultraviolet light. That is, at least a portion of the first operation of obtaining a layer pattern may be carried out simultaneously with the second operation of obtaining a cured layer pattern by irradiating ultraviolet light.

By simultaneously carrying out the printing process and the curing process, the process efficiency of the multilayer electronic component can be improved. In addition, by immediately curing the layer patterns, it is possible to prevent the stacked layer patterns from being mixed with each other, and accordingly, it is possible to secure interface stability between the dielectric patterns, the internal electrode patterns, and the external electrode patterns. As a result, it is possible to provide a method of manufacturing a multilayer electronic component capable of reducing a defect rate.

The method of manufacturing the multilayer electronic component according to an exemplary embodiment of the present disclosure may include a sintering operation of obtaining the multilayer electronic component by sintering the laminate 10 formed through the above-described processes. By sintering the laminate 10, the multilayer electronic component 100 illustrated in FIGS. 1 and 2 may be obtained.

A sintering temperature for the sintering operation is not particularly limited, but at least a portion of the sintering operation may include a process of sintering the laminate 10 at a predetermined temperature or higher capable of eliminating the support pattern 41-1. Thus, the sintering operation may include a process of eliminating the support pattern 41-1.

During the process of manufacturing the multilayer electronic component, the support pattern 41-1, which serves to maintain the shape of the laminate 10, is eliminated by sintering without performing a separate process. Therefore, the multilayer electronic component can be efficiently manufactured.

Although a method of forming one multilayer electronic component has been described above as an example of the method of manufacturing the multilayer electronic component, but the present disclosure is not limited thereto. After forming a plurality of laminates simultaneously, the plurality of laminates may be cut out and sintered to form a plurality of multilayer electronic components.

As set forth above, according to the exemplary embodiment in the present disclosure, it is possible to provide a method of manufacturing a multilayer electronic component with excellent process efficiency.

In addition, it is possible to provide a method of manufacturing a multilayer electronic component capable of reducing a defect rate by improving interface stability between dielectric patterns, internal electrode patterns, and external electrode patterns.

While exemplary embodiments have been shown and described above, it will be apparent to those skilled in the art that modifications and variations could be made without departing from the scope of the present disclosure as defined by the appended claims.

What is claimed is:

1. A method of manufacturing a multilayer electronic component including a body comprising dielectric layers and a plurality of internal electrodes stacked with the dielectric layers interposed therebetween, and external electrodes disposed externally on the body, the method comprising:
a first operation of obtaining a layer pattern constituting one layer by performing at least one of a process of forming a dielectric pattern by ejecting a ceramic ink containing a dielectric material and a first photocurable resin, a process of forming an internal electrode pattern by ejecting a first metal ink containing conductive particles for the internal electrodes and a second photocurable resin, and a process of forming external electrode patterns by ejecting a second metal ink containing conductive particles for the external electrodes and a third photocurable resin;
a second operation of obtaining a cured layer pattern by irradiating the layer pattern with ultraviolet light to cure the layer pattern;
an operation of obtaining a laminate in which a plurality of cured layer patterns are stacked by carrying out a plurality of the first and second operations; and
a sintering operation of obtaining the multilayer electronic component by sintering the laminate.

2. The method of claim 1, wherein the process of forming the external electrode patterns includes a process of forming a first external electrode pattern disposed at one end of the dielectric pattern, and a process of forming a second external electrode pattern disposed at the other end of the dielectric pattern, and
at least one of the plurality of the first operations includes all of the process of forming the first external electrode pattern, the process of forming the second external electrode pattern, and the process of forming the dielectric pattern.

3. The method of claim 1, wherein the process of forming the internal electrode pattern includes a process of forming one of first and second internal electrode patterns alternately disposed with the dielectric pattern interposed therebetween,
the process of forming the external electrode patterns includes a process of forming a first external electrode pattern disposed at one end of the first internal electrode pattern, and a process of forming a second external electrode pattern spaced apart from the first internal electrode pattern, and
at least one of the plurality of the first operations includes all of the process of forming the first external electrode pattern, the process of forming the second external electrode pattern, and the process of forming the first internal electrode pattern.

4. The method of claim 3, wherein at least one of the plurality of the first operations further includes a process of forming a first step absorbing pattern disposed between the first internal electrode pattern and the second external electrode pattern by ejecting the ceramic ink.

5. The method of claim 1, wherein at least a portion of the first operation is carried out simultaneously with the second operation.

6. The method of claim 1, wherein at least one of the plurality of the first operations further includes a process of forming a support pattern constituting at least a portion of an external shape of the laminate by ejecting an organic ink containing an organic material.

7. The method of claim 6, wherein the sintering operation includes a process of eliminating the support pattern.

8. The method of claim 1, wherein at least one of the first, second, and third photocurable resins includes an oligomer, a monomer, and a photopolymerization initiator.

9. The method of claim 1, wherein each of the first metal ink and the second metal ink contains a ceramic material.

10. A method of manufacturing a multilayer electronic component including a body comprising dielectric layers and a plurality of internal electrodes stacked with the dielectric layers interposed therebetween, and external electrodes disposed externally on the body, the method comprising:
a first operation of obtaining a layer pattern constituting one layer, the first operation includes forming external electrode patterns by ejecting a metal ink containing conductive particles for external electrodes and a photocurable resin to form the external electrodes; and
a second operation of obtaining a cured layer pattern by irradiating the layer pattern with ultraviolet light to cure the layer pattern,
wherein at least a portion of the first operation is carried out simultaneously with the second operation.

11. The method of claim 10, wherein the layer pattern comprises a photocurable resin.

12. The method of claim 11, wherein the layer pattern includes a dielectric pattern.

13. The method of claim 12, wherein the layer pattern further includes an internal electrode pattern.
